(19) United States
(12) Patent Application Publication
(10) Pub. No.: US 2011/0032323 A1
(43) Pub. Date: Feb. 10, 2011

(54) IMAGE FORMING APPARATUS, LIGHT-INTENSITY CORRECTION METHOD, AND COMPUTER PROGRAM PRODUCT

(76) Inventors: Hidetoshi YAMASHITA, Kanagawa (JP); Norihiro Yamamoto, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/845,368

(22) Filed: Jul. 28, 2010

(30) Foreign Application Priority Data
Aug. 5, 2009 (JP) 2009-182812

(51) Int. Cl. B41J 2/435

(52) U.S. Cl. 347/246

(57) ABSTRACT

An image forming apparatus includes a light source that emits light beam; an illumination-current generating unit that generates an illumination current that causes the light source to emit the light beam; a deflecting optical unit, thereby forming a light spot and scanning the scanned surface; a detecting unit that detects a scanning position of the light spot on the scanned surface; a control unit that calculates a relation between a value of the illumination current and an intensity of light based on a plurality of intensities of emitted light, each intensity of the plurality of intensities being close to or equal to a prescribed light intensity, and causes the illumination-current generating unit to generate the illumination current based on the relation.

### CROSS-REFERENCE TO RELATED APPLICATIONS

The present application claims priority to and incorporates by reference the entire contents of Japanese Patent Application No. 2009-182812 filed in Japan on Aug. 5, 2009.

### BACKGROUND OF THE INVENTION

1. Field of the Invention

The present invention relates to an image forming apparatus, a light-intensity correction method, and a computer program product.

2. Description of the Related Art

In a typical optical writing device used in an image forming apparatus, as a laser beam passes through an fθ lens and an fθ mirror, the scanning speed over a scanned surface is substantially constant; however, the intensity of the laser beam on the scanned surface varies according to the image height (scanning position). One reason for the varying intensity is that, after the laser beam emitted from a laser diode and before reaching the scanned surface, the laser beam passes through optical elements such as glass, lenses, and mirrors whose light use-efficiencies such as the reflectance and the transmittance are different according to the incident angle of the laser beam. Another reason is that the thickness of the fθ lens is different depending on the image height. The variation in the beam intensity depending on the image height is called the shading characteristic. Shading characteristics vary, in general, over a range of 10% or more and the shading characteristics affect the density of the image being formed.

There are various shading correction technologies that can reduce the affects caused by shading characteristics. For example, Japanese Patent Application Laid-open No. 2000-071510 discloses a technology that is used to provide a beam-scanning image forming apparatus. The beam-scanning image forming apparatus includes a light source unit that generates one beam of light, a deflecting unit that deflects the beam of light for scanning, a scanning/image forming optical unit that projects the beam of light as a light spot on the surface to be scanned and scans the surface with the light spot, and a scanning-position detecting unit that detects the scanning position (image height) of the light spot. The image forming apparatus adjusts, in accordance with the detected scanning position and on the basis of the light-intensity correction data that is provided in advance, the intensity of light emitted from the light source for each scanning line of one beam of light. With this conventional technology, the scanning-position detecting unit has a resolution for detecting discrete points on the scanned positions, the entirety of which is separated into blocks with equal scanning positions, and the light-intensity correction data is stored in a storage unit assigned to each block. The image forming apparatus performs the light-intensity correction for each block using the corresponding light-intensity correction data.

Moreover, for example, Japanese Patent Application Laid-open No. 2003-320703 discloses a technology that is used to perform a shading correction for a light source that generates a plurality of beams of light.

Moreover, according to a shading correction technology disclosed in, for example, Japanese Patent Application Laid-open No. 2003-060289, as means for changing the intensity of light emitted from the light source by referring to the light-intensity correction data, the current that is applied to the light source is separated into three types, i.e., a bias current, a threshold current, and an illumination current, in accordance with the current/light-intensity characteristics (hereinafter, “I-L curve”) shown in FIG. 20. With the shading correction technology disclosed in Japanese Patent Application Laid-open No. 2003-060289, the amount of intensity emitted from the light source is adjusted by changing the illumination current by referring to the light-intensity correction data. If, for example, the light-intensity correction data corresponding to a certain position of the image height indicates a 10% increase in the intensity of light, because it is assumed that the intensity of light emitted is directly proportional to the illumination current, i.e., the I-L curve is linear, the illumination current is increased by 10% in order to increase the intensity of light by 10%.

However, some light sources may have non-linear I-L curves, as shown in FIG. 21. With the shading correction technology disclosed in Japanese Patent Application Laid-open No. 2003-060289, if, for example, it is necessary to increase the intensity of light by 10%, the illumination current is increased by 10%. However, if the I-L curve is non-linear, as shown in FIG. 22, even though the illumination current is increased by 10%, the intensity of light is increased by only for example 8%, which is lower than 10%.

In the above situation, according to the technology disclosed in Japanese Patent Application Laid-open No. 2003-320703, even when the illumination current to be applied to the light source is adjusted by referring to the scanning-position-based light-intensity correction data so as to set the intensity of the laser beam to be constant along a scanning line over the scanned surface, the actual intensity of light on the scanned surface is different from the target intensity of light and, as a result, the intensity of the laser beam is not constant over the scanning line.

Moreover, according to the technology disclosed in Japanese Patent Application Laid-open No. 2003-320703, the shading correction is performed for a plurality of laser beams in the same manner as in the manner disclosed in both Japanese Patent Application Laid-open No. 2000-071510 and Japanese Patent Application Laid-open No. 2003-060289; therefore, the intensity of each laser beam cannot be corrected to the target intensity of light and, as a result, large differences occur among the intensities of the laser beams, which leads to an image with periodical density unevenness (banding).

The conventional laser diodes emit one to four, or up to about eight laser beams, from one semiconductor element; however, in recent years, vertical cavity surface emitting lasers (VCSELs) have become available commercially and thus optical writing devices have been used in practical applications that use ten or more laser beams for one scan.

### SUMMARY OF THE INVENTION

It is an object of the present invention to at least partially solve the problems in the conventional technology.

According to an aspect of the present invention, there is provided an image forming apparatus including: a light source that emits light beam; an illumination-current generating unit that generates an illumination current that causes the light source to emit the light beam; a deflecting optical unit that deflects the light beam and collects the deflected light beam on a scanned surface of a photosensitive element, thereby forming a light spot and scanning the scanned surface with the light spot; a detecting unit that detects a scanning position of the light spot on the scanned surface; a control unit that calculates a relation between a value of the illumination current and an intensity of light emitted from the light source based on a plurality of intensities of emitted light, each intensity of the plurality of intensities being close to or equal to a prescribed light intensity, and causes the illumination-current generating unit to generate the illumination current based on the relation; and a correcting unit that corrects the intensity of the light beam by correcting the illumination current based on predetermined correction data defined for each scanning position.

According to another aspect of the present invention, there is provided a light-intensity correction method performed in an image forming apparatus, the image forming apparatus including a light source that emits a light beam; an illumination-current generating unit that generates an illumination current, wherein the illumination current causes the light source to emit the light beam; a deflecting optical unit that deflects the light beam and collects the deflected light beam on a scanned surface of a photosensitive element, thereby forming a light spot and scanning the scanned surface with the light spot; and a detecting unit that detects a scanning position of the light spot on the scanned surface; the light-intensity correction method including: calculating a relation between the value of the illumination current and the intensity of light emitted from the light source based on a plurality of intensities of emitted light, each intensity of the plurality of intensities being close to or equal to a prescribed light intensity; causing the illumination-current generating unit to generate the illumination current based on the relation; and correcting the intensity of the light beam by correcting the illumination current based on predetermined correction data defined for each scanning position.

According to still another aspect of the present invention, there is provided a computer program product including a computer-usable medium having computer-readable program codes embodied in the medium for a light-intensity correction method performed in an image forming apparatus, the image forming apparatus including a light source that emits a light beam; an illumination-current generating unit that generates an illumination current, wherein the illumination current causes the light source to emit the light beam; a deflecting optical unit that deflects the light beam and collects the deflected light beam on a scanned surface of a photosensitive element, thereby forming a light spot and scanning the scanned surface with the light spot; and a detecting unit that detects a scanning position of the light spot on the scanned surface; the program codes when executed causing a computer to execute: calculating a relation between the value of the illumination current and the intensity of light emitted from the light source based on a plurality of intensities of emitted light, each intensity of the plurality of intensities being close to or equal to a prescribed light intensity; causing the illumination-current generating unit to generate the illumination current based on the relation; and correcting the intensity of the light beam by correcting the illumination current based on predetermined correction data defined for each scanning position.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of the mechanical configuration of an image forming apparatus according to a first embodiment;

FIG. 2 is a schematic diagram of a configuration of a light source unit, the light source unit being either a laser diode array or a surface emitting laser;

FIG. 3 is a schematic perspective view of an optical device in which a VCSEL irradiates a drum-shaped photosensitive element;

FIG. 4 is a functional block diagram of a control unit of the image forming apparatus;

FIG. 5 is a detailed functional block diagram of a GAVD;

FIG. 6 is a schematic diagram that explains the relation between an input pulse signal and current applied to the light source;

FIG. 7 is a graph that is used to calculate a threshold current and an illumination current in a conventional manner;

FIG. 8 is a graph that is used to calculate the threshold current and the illumination current according to a conventional manner;

FIG. 9 is a graph showing the threshold current and the illumination current that are calculated using the proportional relation between the amount of current and the intensity of light emitted according to the first embodiment;

FIG. 10 is an enlarged view of the section that includes the prescribed light intensity shown in FIG. 9;

FIG. 11 is a schematic diagram of the scanned surface of the photosensitive element and the shading characteristics;

FIG. 12 is a functional block diagram of a synchronization detecting device;

FIG. 13 is a circuit block diagram of an output-data control unit of the GAVD;

FIG. 14 is a graph that is used for explaining light-intensity correction;

FIG. 15 is a timing chart of a synchronization signal (XDETP) and a light-intensity correction signal LDLVL when an effective writing area is separated into 15 equal blocks;

FIG. 16 is a functional block diagram of an LD driver;

FIG. 17 is a flowchart of a process for calculating and setting the threshold current and the illumination current according to the first embodiment;

FIG. 18 is a graph that explains the relation between the current applied to the light source of the VCSEL 200 and voltage Vpd, where the voltage Vpd indicates the intensity of light emitted;

FIG. 19 is a flowchart of a process for calculating and setting the threshold current and the illumination current according to a second embodiment;

FIG. 20 is an example of a graph of the current/light-intensity characteristics (I-L curve) of the light source;

FIG. 21 is an example of a non-linear graph of current/light-intensity characteristics (I-L curve); and

FIG. 22 illustrates how light-intensity correction is performed using an example of a non-linear graph of the current/light-intensity characteristics (I-L curve).

### DETAILED DESCRIPTION OF THE PREFERRED EMBODIMENTS

Exemplary embodiments of image forming apparatus, light-intensity correction method, and computer programs according to the present invention are described in detail below with reference to the accompanying drawings. It is noted that the present invention is not limited to these embodiments.

### First Embodiment

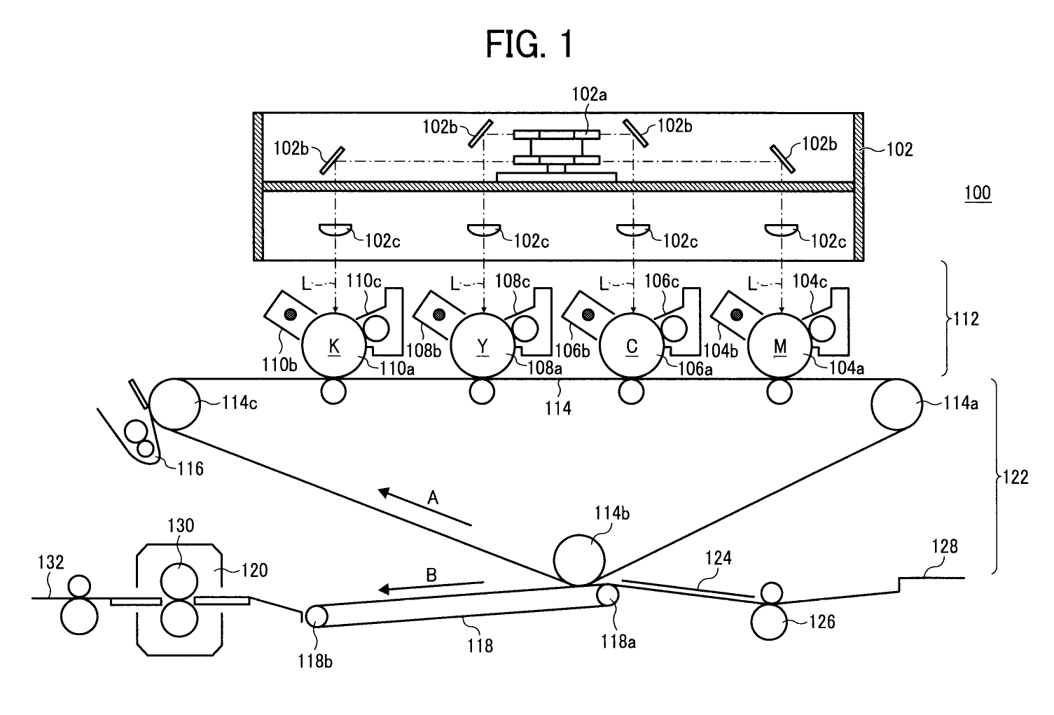

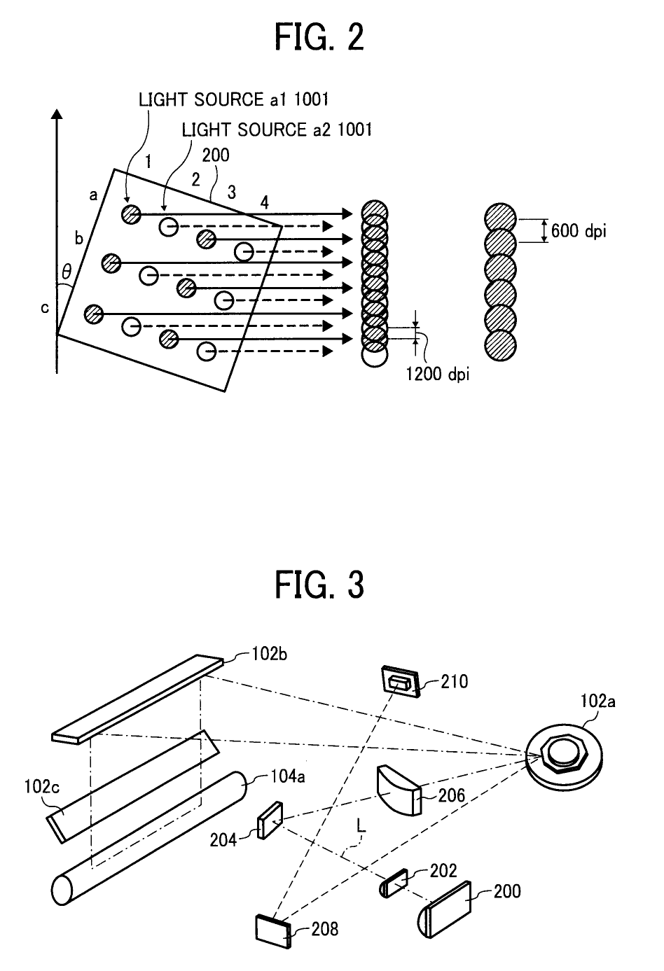

FIG. 1 is a schematic diagram of the mechanical configuration of an image forming apparatus according to a first embodiment. An image forming apparatus 100 according to the present embodiment includes a vertical cavity surface emitting laser (VCSEL) 200 (see FIGS. 2 and 3); an optical device 102 that includes optical elements such as a polygon mirror 102a; an image forming unit 112 that includes drum-shaped photosensitive elements, charging devices, developing devices, etc.; and a transferring unit 122 that includes an intermediate transfer belt, etc. The optical device 102 includes the VCSEL 200 that is a laser diode. In the embodiment shown in FIG. 1, a beam of light (laser beam) emitted from the VCSEL 200 (not shown in FIG. 1) converges by operation of a first cylindrical lens (not shown), and then the convergent light is deflected by the polygon mirror 102a toward reflecting mirrors 102b.

The VCSEL 200 is a vertical cavity surface emitting laser in which a plurality of laser diode elements (hereinafter, also called “light sources”) are mounted on the same chip, arranged in a grid pattern. There are various widely-known technologies related to an image forming apparatus using such a VCSEL and the VCSEL 200 is incorporated in the optical device 102 of the image forming apparatus 100 according to the present embodiment in the same manner as those used in the well-known technologies. FIG. 2 is a schematic diagram of the configuration of the VCSEL 200 incorporated in the optical device 102 according to the present embodiment. As shown in FIG. 2, the VCSEL 200 in the present embodiment is a laser diode array and includes a plurality of light sources 1001 (a plurality of laser diode elements), arranged in a grid pattern. The array direction of the light sources 1001 makes a predetermined angle θ with the rotation axis of the polygon mirror 102a that is a deflector.

As shown in FIG. 2, the positions of the light sources are represented by Lines a to c and Columns 1 to 4 and, for example, the light source 1001 on the upper left is represented by “a1”. Because the set of the light sources 1001 makes the angle θ with the polygon mirror, the scanning position exposed by the light source a1 is different from the scanning position exposed by the light source a2. Suppose a case where these two light sources together form one pixel, i.e., in the example shown in FIG. 2, a pair of light sources forms one pixel. If it is assumed that the two light sources a1 and a2 together form one pixel and the two light sources a3 and a4 together form one pixel, then pixels are formed by the light sources as shown in the right section of FIG. 2. It is assumed that the up-and-down direction of FIG. 2 corresponds to the sub-scanning direction and the distance between the centers of adjacent pixels is about 600 dpi. In this situation, the distance between the centers of each pair of light sources forming one pixel is about 1200 dpi and the light-source density is twice as high as the pixel density. Therefore, the barycenter of one pixel can be shifted in the sub-scanning direction by changing the ratio between the intensities of light emitted from the pair of light sources forming the pixel, which enables a highly accurate image formation.

The optical device 102 used in the image forming apparatus 100 is a post-object oriented optical device having no fθ lens. In the embodiment shown in FIG. 1, a plurality of beams for each of colors including cyan (c), magenta (M), yellow (Y), and black (K) are generated as light beams L. The light beams L is reflected by the reflecting mirrors 102b and then collected by second cylindrical lenses 102c. After that, the light beams L irradiate photosensitive elements 104a, 106a, 108a, and 110a.

Because, as described above, irradiation by the light beams L is performed by means of the two or more optical elements, timing synchronization is performed in both the main-scanning direction and the sub-scanning direction. It is assumed, herein, that the main-scanning direction corresponds to the light-beam scanning direction and the sub-scanning direction corresponds to the direction perpendicular to the main-scanning direction.

Each of the photosensitive elements 104a, 106a, 108a, and 110a includes a conductive drum-shaped member that is made of, for example, aluminum and a photoconductor layer that is formed on the conductive drum-shaped member. The photoconductor layer includes a charge generating layer and a charge transporting layer. The photoconductor layers are arranged corresponding to the photosensitive elements 104a, 106a, 108a, and 110a, respectively and a surface charge is applied to the photoconductor layers by chargers 104b, 106b, 108b, and 110b, respectively. Each charger includes a corotron, a scorotron, a charging roller, or the like.

After the electrostatic charge is applied onto the photosensitive elements 104a, 106a, 108a, and 110a by the chargers 104b, 106b, 108b, and 110b, the photosensitive elements 104a, 106a, 108a, and 110a are exposed to the light beams L and, thus, electrostatic latent images are formed. The latent images formed on the photosensitive elements 104a, 106a, 108a, and 110a are developed into developing material images by developers 104c, 106c, 108c, and 110c, respectively. Each developer includes a developing sleeve, a developing-material supply roller, a shaping blade, etc.

The developing materials are transferred from the photosensitive elements 104a, 106a, 108a, and 110a onto an intermediate transfer belt 114 moving in the direction indicated by an arrow A by rotation of conveying rollers 114a, 114b, and 114c. With the C, M, Y, and K developing materials carried thereon, the intermediate transfer belt 114 moves to a secondary transferring unit. The secondary transferring unit includes a secondary transfer belt 118 and conveying rollers 118a and 118b. The secondary transfer belt 118 moves in the direction indicated by an arrow B by rotation of the conveying rollers 118a and 118b. To the secondary transferring unit, an image receiving material 124, such as a paper sheet of a plastic sheet, is fed from an image-receiving-material accommodating unit 128, such a paper feed cassette, by a conveying roller 126.

The secondary transferring unit transfers the multi-color developing-material image from the intermediate transfer belt 114 to the image receiving material 124 by applying a secondary transfer bias, the image receiving material 124 being attracted and attached onto the secondary transfer belt 118. The image receiving material 124 is conveyed to a fixing device 120 by rotation of the secondary transfer belt 118. The fixing device 120 includes a fixing member 130 made of, for example, silicon rubber or fluorine-containing rubber. The fixing device 120 applies heat and pressure to the image receiving material 124 with the multi-color developing-material image. The product is discharged from the image forming apparatus 100 as a printed material 132. After the multi-color developing-material image is transferred from the intermediate transfer belt 114, residual toners are removed from the intermediate transfer belt 114 by a cleaning unit 116 that includes a cleaning blade so that the belt is cleaned for the next image forming process.

FIG. 3 is a perspective view of the optical device 102 in which the VCSEL 200 irradiates the photosensitive element 104a. After emitted from the VCSEL 200, the light beam L is collected by a first cylindrical lens 202 that is used to shape the light beams. After passing through a reflecting mirror 204 and an imaging lens 206, the light beam L is deflected by the polygon mirror 102a. The polygon mirror 102a is rotated by a spindle motor or similar that rotates from some thousands to some ten thousands. After reflected by the polygon mirror 102a, the light beam L is further reflected by the reflecting mirror 102b and then shaped by the second cylindrical lens 102c. After that, the light beam L illuminates the photosensitive element 104a.

A reflecting mirror 208 is used for synchronizing scanning start timing of the light beams L in the sub-scanning direction. The reflecting mirror 208 reflects the light beam L toward a synchronization detecting device 210 before the start of scanning in the sub-scanning direction. The synchronization detecting device 210 includes a photodiode, etc. Upon detecting the light beam, the synchronization detecting device 210 generates a synchronization signal so as to start the scanning in the sub-scanning direction, thereby synchronizing processes including a process of generating a driving control signal that is sent to the VCSEL 200.

The VCSEL 200 is driven by an input pulse signal received from a GAVD 310 which will be described later. As will be described in detail later, the light beam L illuminates the position corresponding to a predetermined image bit of image data and a latent image is formed on the photosensitive element 104a.

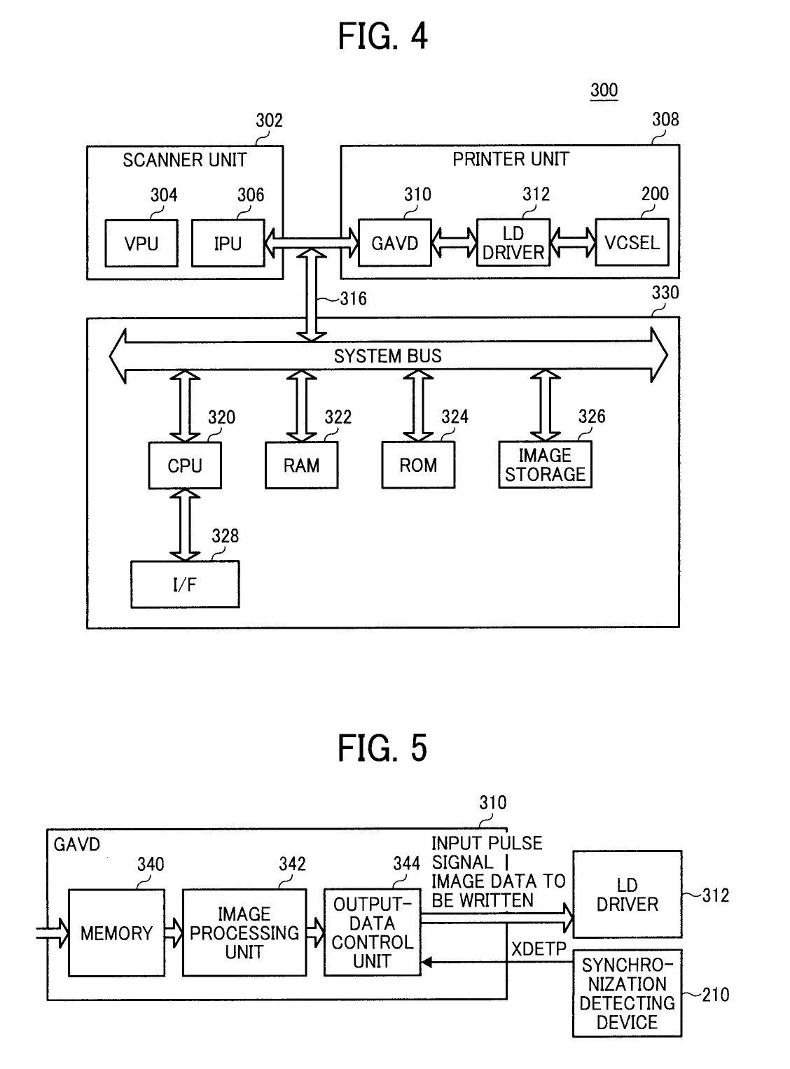

FIG. 4 is a functional block diagram of a control unit 300 of the image forming apparatus 100. The control unit 300 includes a scanner unit 302, a printer unit 308, and a main control unit 330. The scanner unit 302 reads an image. The scanner unit 302 includes a VPU 304 and an IPU 306. The VPU 304 processes a signal read by the scanner using A/D conversion and performs black offset correction, shading correction, and pixel position correction. The IPU 306 performs image processing for converting an acquired RGB color-based image data to a CMYK color-based digital image data. The scanned image acquired by the scanner unit 302 is sent to the printer unit 308 as digital data.

The printer unit 308 includes the GAVD 310 that controls the VCSEL 200; an LD driver 312 that generates current (illumination current, threshold current, and bias current) and supplies the generated current to the laser diode elements, the current being used to operate the laser diode elements or the light sources in response to the input pulse signal generated by the GAVD 310; and the VCSEL 200 that includes the two-dimensionally arranged laser diode elements (light sources). Upon receiving the image data from the scanner unit 302, the GAVD 310 according to the present embodiment performs a high-resolution process by dividing the image data into pieces in accordance with the spatial size of the laser diode element of the VCSEL 200.

Both the scanner unit 302 and the printer unit 308 are connected to the main control unit 330 via a system bus 316, and thus the image scanning and the image forming are controlled using instructions of the main control unit 330. The main control unit 330 includes a central processing unit (CPU) 320 and a RAM 322 that is used as an execution space when the CPU 320 executes processes. Any of known CPUs can be used as the CPU 320, for example, Pentium (registered trademark) series or CPUs compatible with Pentium series, reduced instruction set computers (RISCs), such as complex instruction set computers (CISCs) and MIPSs, etc. The CPU 320 receives instructions from a user via an interface (I/F) 328, reads out and activates a program module for executing the process corresponding to the instruction, and performs, for example, the copy process, the facsimile process, the scanner process, the image storage process, etc. The main control unit 330 further includes a ROM 324 and stores default setting data, control data, computer programs, etc., for the CPU 320 in the ROM 324 available to the CPU 320. An image storage 326 is a stationary memory device, such as a hard disk drive, or a detachable memory device, such as an SD card and a USB memory. The image storage 326 stores therein the image data acquired by the image forming apparatus 100 so that the image data is available for various user-specified processing.

During a process of image forming, using the printer unit 308, a latent image on the photosensitive element 104a or similar in accordance with the image data that is acquired by the scanner unit 302, the CPU 320 adjusts the position of the image receiving material that is made of, for example, paper or plastic film in both the main-scanning direction and the sub-scanning direction. When scanning in the sub-scanning direction starts, the CPU 320 outputs a start signal to the GAVD 310. When the GAVD 310 receives the start signal, the IPU 306 starts the scanning process. After that, the GAVD 310 receives the image data from a buffer memory, processes the received image data, and outputs the processed image data to the LD driver 312. Upon receiving the image data from the GAVD 310, the LD driver 312 generates a drive control signal for controlling the VCSEL 200. After that, the LD driver 312 sends the driving control signal to the VCSEL 200, thereby causing each light source (laser diode element) of the VCSEL 200 to emit light. The LD driver 312 drives the laser diode elements using a PWM control. The VCSEL 200 has, in the present embodiment, laser diode elements for eight channels. The number of channels of the VCSEL can be more than or less than eight.

FIG. 5 is a detailed functional block diagram of the GAVD 310. The GAVD 310 includes a memory 340, such as a FIFO buffer. The GAVD 310 receives a synchronization signal (XDETP) and stores the image data received from the IPU 306 in the memory 340. The GAVD 310 sends the image data that has been received from the IPU 306 to an image processing unit 342 first in first out. The image processing unit 342 reads the image data from the memory 340 and performs various processes including image-data resolution conversion, assignment of the channels to the laser diode elements, image bit addition/deletion, and the like. The position on the photosensitive element 104a to be exposed in accordance with the image data is defined by both the main-scanning line address value in the main-scanning direction and the sub-scanning line address value in the sub-scanning direction.

An output-data control unit 344 performs processes with respect to the synchronization signal (XDETP) that is generated when the synchronization detecting device 210 detects the light beam coming from the VCSEL 200. The output-data control unit 344 outputs a line-data request signal to the image processing unit 342 for raster data, in response to a write start signal (not shown). Moreover, the output-data control unit 344 sends image data to be written and an input pulse signal that is used for driving the VCSEL 200 to the LD driver 312.

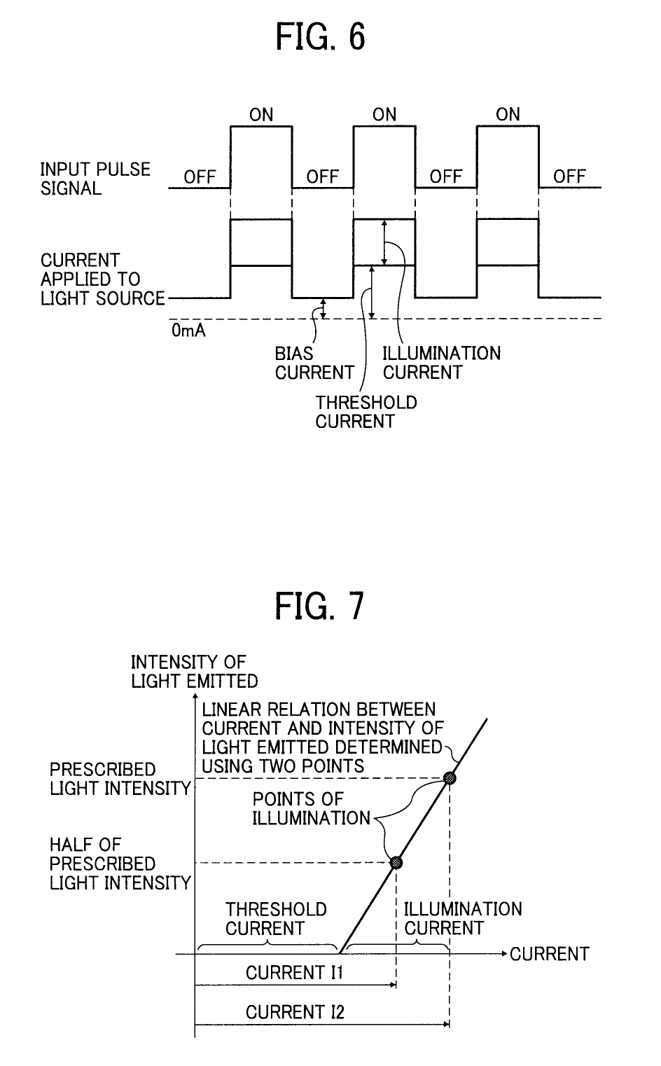

A typical LD driver includes a bias-current generating circuit that always supplies a small bias current to each light source of the VCSEL 200, a threshold-current generating circuit that supplies a threshold current to each light source, and an illumination-current generating circuit that generates an illumination current so that each light source emits light in response to the input pulse signal. FIG. 6 is a schematic diagram that explains the relation between the input pulse signal and the current applied to the light source. As shown in FIG. 6, when the input pulse signal is off, only the bias current is applied to each light source. When the input pulse signal is on, the current containing both the threshold current and the illumination current is applied to each light source.

During a process for generating the threshold current and the illumination current, a control unit that controls both the threshold-current generating circuit and the illumination-current generating circuit applies two different currents I1 and I2 to the light source and measures the intensity of light emitted corresponding to each current. The control unit then calculates the proportional relation between the amount of current applied and the intensity of light emitted by using the two current values and the two intensities of light emitted so as to plot the two points of illumination shown in FIG. 7 and then to determine the point on the graph where a straight line defined by the two points of illumination intersects with the current axis. This point of intersection is the threshold current. The control unit also determines the illumination current that is necessary for the intensity of light emitted to increase to a prescribed light intensity to be an increased amount of current above the threshold current. The prescribed light intensity is equal to the target intensity of the light beam on the scanned surface of the photosensitive element 104a.

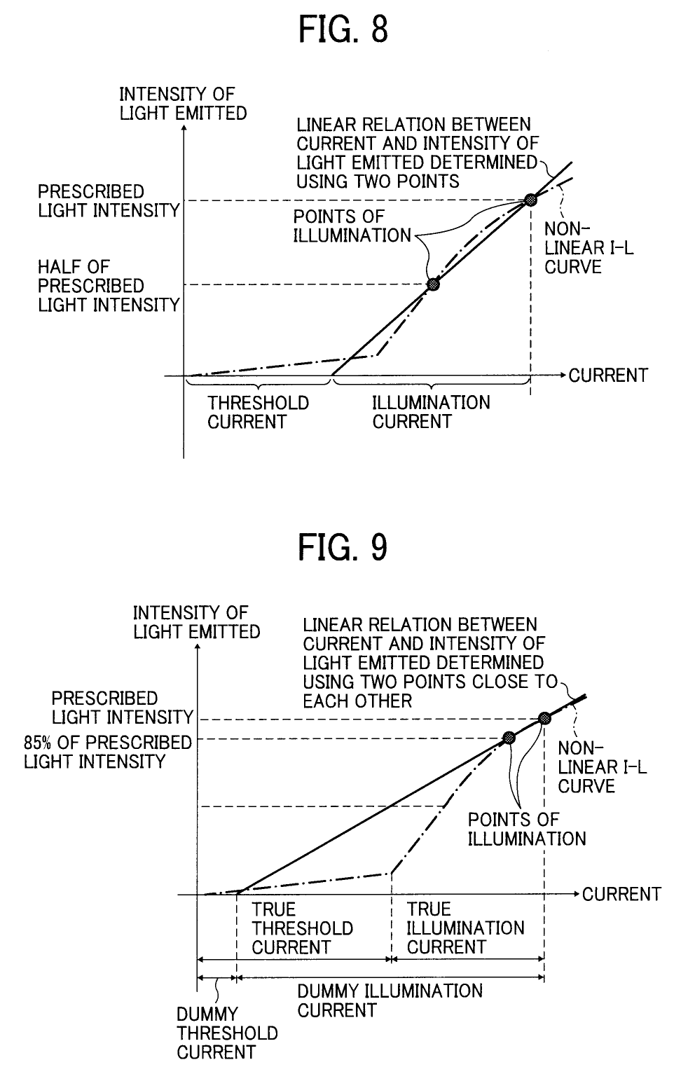

As shown in FIG. 7, the conventional technique for calculating the threshold current and the illumination current involves applying both the current value corresponding to the prescribed light intensity and the current value corresponding to about half of the prescribed light intensity to the light source, and calculating the threshold current and the illumination current by using a straight line passing through the two points. However, when calculated in the conventional technique, the proportional relation between the amount of current and the intensity of light emitted is calculated with points that are indicative of the intensities of light emitted and are relatively distant from each other. In this situation, if the I-L curve is non-linear, the calculated proportional relation between the amount of current and the intensity of light emitted deviates from the actual I-L curve, as shown in FIG. 8. Therefore, it may occur such a problem as even if the illumination current is increased by 10% during the shading correction so as to increase the intensity of light by 10%, the actual intensity of light would be increased by only, for example, 8%.

In contrast, in the present embodiment, the proportional relation between the amount of current and the intensity of light emitted is calculated using two points of the intensities of light emitted, one being the prescribed light intensity and the other being an intensity close to the prescribed light intensity (e.g., 85% of the prescribed light intensity). FIG. 9 is a graph showing the threshold current and the illumination current that are calculated using the graph. As shown in FIG. 9, a value different from the true threshold current is set as a pseudo threshold current and a value different from the true illumination current is set as a pseudo illumination current.

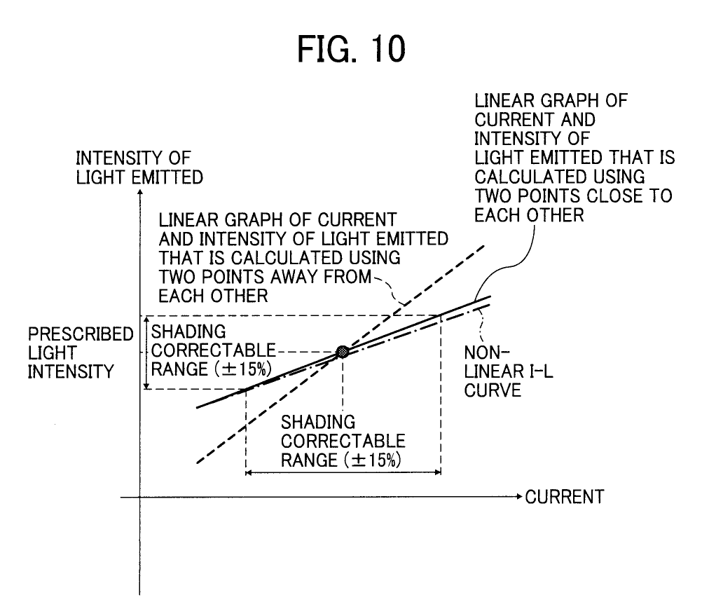

FIG. 10 is an enlarged view of the section that includes the prescribed light intensity shown in FIG. 9. As shown in FIG. 10, the proportional relation between the amount of current and the intensity of light emitted that is calculated in the present embodiment using the prescribed light intensity and the intensity close to the prescribed light intensity (e.g., 85% of the prescribed light intensity) is closer to the actual I-L curve than the proportional relation that is calculated in the conventional technique using the prescribed light intensity and the intensity that is relatively distant from the prescribed light intensity (e.g., half of the prescribed light intensity). Therefore, in the present embodiment, even if the I-L curve is non-linear, an accurate shading correction is performed by using the illumination current that is calculated in the above manner.

Moreover, as shown in FIG. 10, the intensity of light is adjusted during the shading correction to a value within, in general, a relatively small range from −15% to +15% with respect to the prescribed light intensity; therefore, the I-L curve is a substantially straight line within this range. Further, the proportional relation between the amount of current and the intensity of light emitted is calculated using a light intensity close to the prescribed light intensity; therefore, the I-L curve is substantially equal to the proportional relation between the amount of current and the intensity of light emitted calculated in the present embodiment, which enables a highly accurate adjustment of the intensity of light. This enables scanning of the scanned surface of the photosensitive element 104a with the light beam that has a constant intensity.

Especially, because the VCSEL 200 is used in the present embodiment that includes a plurality of light sources (laser diode elements) and the surface of the photosensitive element 104a is scanned with two or more light beams, the differences between the amounts of the light beams are reduced, which prevents forming of a undesirable image with, for example, banding and enables to print preferable image.

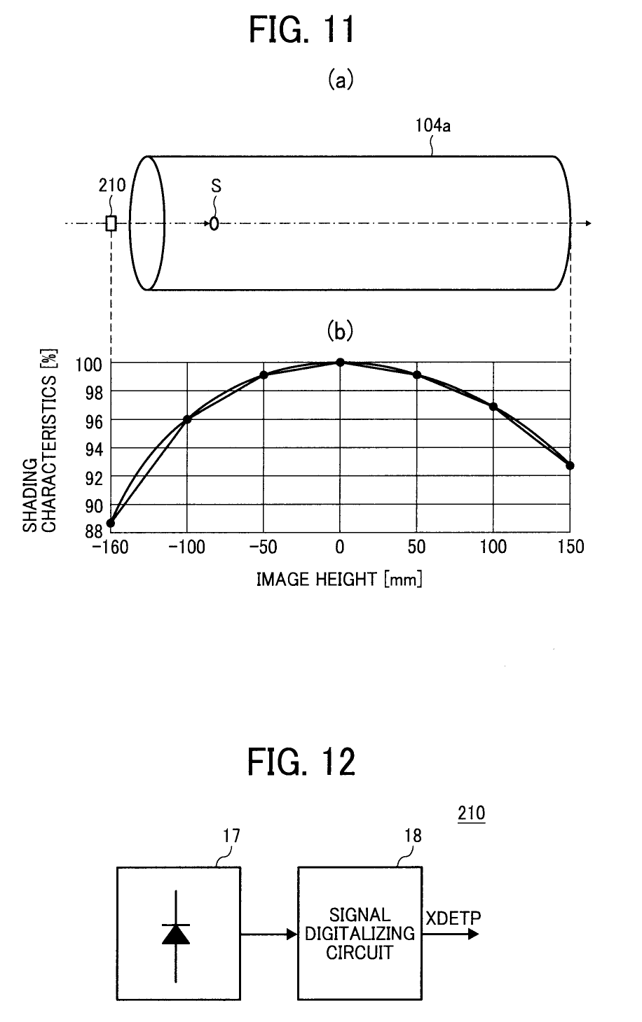

The present embodiment is described in detail below. FIG. 11 is a schematic diagram of the scanned surface of the photosensitive element 104a and the shading characteristics. Section (a) of FIG. 11 illustrates the scanned surface of the photosensitive element 104a. Section (b) is a graph of the shading characteristics of the image forming apparatus according to the present embodiment. More particularly, the graph shown in Section (b) of FIG. 11 is the intensity of the light beam (the intensity of the light beam forming a light spot S) on the scanned surface of the photosensitive element 104a when the light source of the VCSEL 200 emits the same intensity of light at every image height.

The synchronization detecting device 210 is provided at the position of the image height −160, where the center in the main-scanning direction is assumed to be the image height 0. An effective writing area corresponds to an area from the image height −150 to the image height +150.

FIG. 12 is a functional block diagram of the synchronization detecting device 210. The synchronization detecting device 210 according to the present embodiment includes a PIN photodiode 17, as shown in FIG. 12, that is a light receiving element and that receives the light beams and performs photoelectric conversion; and a signal digitalizing circuit 18 that converts an output signal of the PIN photodiode 17 to an on/off digital signal.

When the PIN photodiode 17 receives the light beam, the synchronization detecting device 210 outputs a low-level synchronization signal (XDETP). Although, in the present embodiment, an IC is used as the synchronization detecting device 210 that include the PIN photodiode 17 (light receiving element) and the signal digitalizing circuit 18 (electric circuit), both accommodated into the same package, the configuration is not limited thereto. It is allowable to separate the PIN photodiode 17 from the signal digitalizing circuit 18. Moreover, an optical fiber that guides the light beam can be used as the synchronization detecting device 210.

The synchronization signal (XDETP) is sent from the synchronization detecting device 210 to the output-data control unit 344 of the GAVD 310. The output-data control unit 344 outputs both the image data to be written and a mandatory lightening signal to the LD driver 312 as modulation data, in which the image data to be written has been received from the image processing unit 342 and the mandatory lightening signal is needed to generate the synchronization signal.

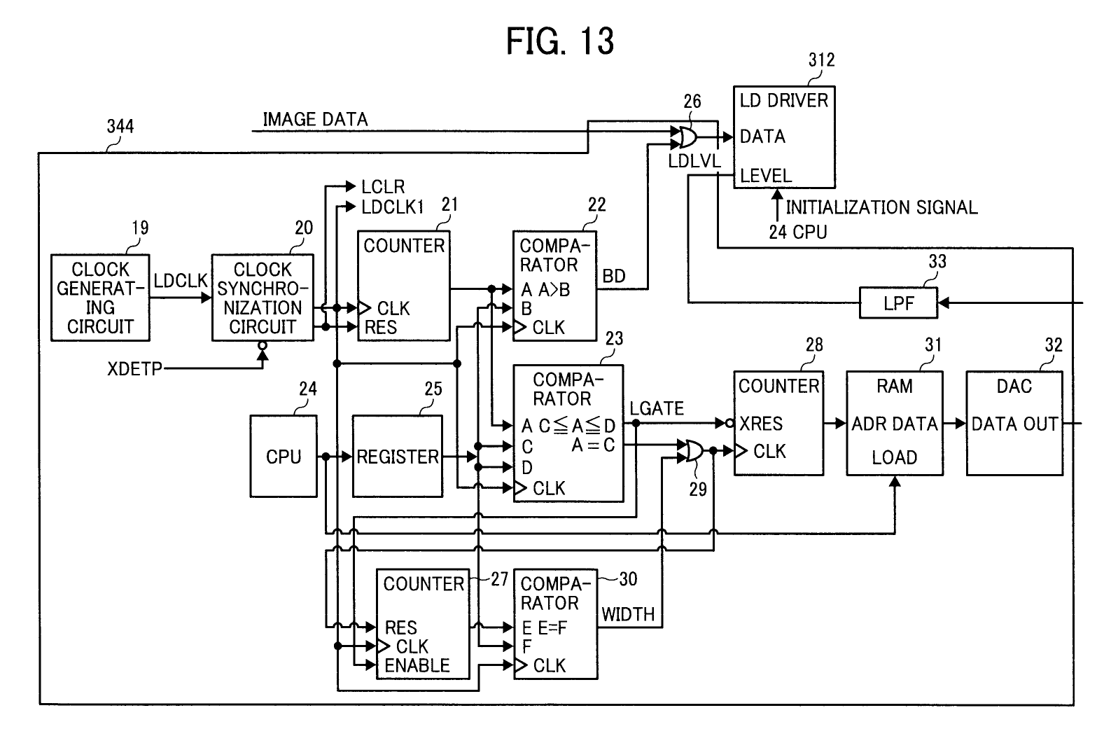

FIG. 13 is a circuit block diagram of the output-data control unit 344 of the GAVD 310. It is noted that only the components related to the present embodiment are illustrated in FIG. 13.

The output-data control unit 344 includes, as shown in FIG. 13, a clock generating circuit 19, a clock synchronization circuit 20, a CPU 24, counters 21, 27, and 28, a register 25, comparators 22, 23, and 30, a random access memory (RAM) 31, and a digital-analog converter (DAC) 32 as main units.

The clock generating circuit 19 is made up of a crystal oscillator and a PLL frequency synthesizer and generates a printing pixel clock LDCLK. The printing pixel clock LDCLK is converted by the clock synchronization circuit 20 into a light-beam modulating clock LDCLK1 with its phase synchronized with the timing of the synchronization signal (synchronization detecting pulse signal) XDETP received from the synchronization detecting device 210.

The synchronization signal (XDETP) received from the synchronization detecting device 210 is synchronized with the light-beam modulating clock LDCLK1 by the clock synchronization circuit 20 and converted to a main-scanning start signal LCLR. Both the light-beam modulating clock LDCLK1 and the main-scanning start signal LCLR are output to an image input unit (not shown), and the image input unit uses them as a clock and a signal for synchronizing the image data with the image writing. More particularly, the image input unit starts transferring the image data to a print control unit 6 piece by piece, each equivalent to one line in response to the main-scanning start signal LCLR and transfers the image data to the print control unit 6 synchronized with the light-beam modulating clock LDCLK1.

The main-scanning start signal LCLR is also sent from the clock synchronization circuit 20 to a reset terminal of the counter 21 so as to reset the counter 21. The counter 21 is a so-called main-scanning counter and resets itself in response to the main-scanning start signal LCLR received from the clock synchronization circuit 20. Moreover, the counter 21 is a binary counter and increments itself in response to the light-beam modulating clock LDCLK1 received from the clock synchronization circuit 20. The count value indicates the position of the light beam in the main-scanning direction.

The counter 21 has a sufficient number of bits for scanning one line without an overflow. More particularly, if an image with 800 dpi is printed on a printing sheet with the width 297 mm in the main-scanning direction, 14 bits are needed. The counter 21 is connected to the two comparators 22 and 23, and the comparator 22 generates a VCSEL 200 mandatory driving signal BD for the light-beam synchronization detection.

The comparator 22 is connected to the CPU 24 via the register 25. The CPU 24 is a numeric-value setting unit and sets a numerical value B as a variable. The comparator 22 compares a count value A of the counter 21 with the numerical value B set by the CPU 24 as a variable and, if the count value A exceeds the setting value B, sets the output signal BD active. The output signal BD is sent from the comparator 22 to an OR gate 26 as a beam detection signal. The OR gate 26 calculates a logical sum of the signal BD and the image data that is received from the image input unit. The LD driver 312 causes the light source of the VCSEL 200 to emit light in accordance with the output signal of the OR gate 26. Thus, the light source of the VCSEL 200 is lightened mandatory in response to the mandatory lighting signal of the OR gate 26. When the light source of the VCSEL 200 is lightened mandatory in response to the mandatory driving signal of the OR gate 26 and the light beam emitted from the light source enters the PIN photodiode 17, which is the light-receiving element of the synchronization detecting device 210, the synchronization signal (XDETP) output from the synchronization detecting device 210 is set active. The synchronization signal (XDETP) is set synchronized with the light-beam modulating clock LDCLK1 by the clock synchronization circuit 20 and output as the main-scanning start signal LCLR so as to reset the counter 21.

The VCSEL 200 mandatory driving signal BD is an output signal of the comparator 22. The comparator 22 compares the count value A of the counter 21 with the numerical value B set by the CPU 24 as a variable and, if the count value A is larger than the setting value B, sets the output signal active. Therefore, when the counter 21 is reset, the mandatory driving signal BD is negated and the light source of the VCSEL 200 is switched off.

When the counter 21 is reset, the counter 21 re-starts counting the light-beam modulating clocks LDCLK1 received from the clock synchronization circuit 20, and thus the counter 21 performs the counting operation repeatedly with each surface of the polygon mirror 102a. In this situation, it is necessary to set the VCSEL 200 mandatory driving timing after the scanning beam coming from the polygon mirror 102a passes over the effective writing area and before the scanning beam deflected by the next surface of the polygon mirror 102a reaches the PIN photodiode 17 of the synchronization detecting device 210, and it is also necessary to prevent a flare; therefore, the CPU 24 sets the setting value B so that the timing is set to immediately before the scanning beam deflected by the next surface of the polygon mirror 102a reaches the PIN photodiode 17 of the synchronization detecting device 210.

The comparator 23 generates an effective writing area signal LGATE, where the effective writing area signal LGATE being at a high level indicates that the light beam is within the effective writing area. The comparator 23 is connected to the CPU 24 via the register 25. The CPU 24 sets numerical values C and D as variables. The comparator 23 compares the count value A of the counter 21 with the numerical values C and D set by the CPU 24 as variables and, if the count value A is more than or equal to the setting value C and less than or equal to the setting value D, sets the output signal LGATE active.

As for the numerical values C and D, the CPU 24 converts each of the distance between the synchronization detecting device 210 and the start position of the effective writing area and the distance between the synchronization detecting device 210 and the end position of the effective writing area into the number of clocks, and writes the numbers of clocks to the register 25 as prestored data readable by the comparator 23; therefore the effective writing area signal LGATE indicates whether the scanning position of the light beam is within the effective writing area. The effective writing area signal LGATE is sent from the comparator 23 to the counter 27.

Moreover, when the count value A of the counter 21 is equal to the setting value C, the comparator 23 generates a pulse signal indicative of the scanning position of the light beam being at the start position of the effective writing area and sends the pulse signal to an OR gate 29. The OR gate 29 calculates a logical sum of the pulse signal and the output signal of the comparator 30. The output signal of the OR gate 29 is sent both to a reset input terminal of the counter 27 and to a count clock input terminal of the counter 28.

The counter 27 and the comparator 30 together separate the entire effective writing area into a plurality of equal blocks by the image height. The counter 27 receives an effective writing area signal LGATE from the comparator 23 as an enable signal, and does not perform the counting operation other than the period when the effective writing area signal LGATE is negative, i.e., outside of the effective writing area.

The counter 27 resets itself in response to the output signal of the OR gate 29 when the effective writing area signal LGATE received from the comparator 23 is switched to active and, at the same time, starts counting the light-beam modulating clocks LDCLK1 received from the clock synchronization circuit 20. The count value of the counter 27 is output to the comparator 30 via the register 25. The comparator 30 is connected to the CPU 24 that sets a numerical value F as a variable.

The comparator 30 compares a count value E of the counter 27 with the numerical value F set by the CPU 24 as a variable and, if the count value E is equal to the setting value F, generates a pulse signal WIDTH to separate the effective writing area into blocks. The CPU 24 converts the width of each block of the effective writing area into the number of clocks LDCLK1 and writes the number of clocks to the register 25 as prestored data, thereby setting the numerical value F.

The pulse signal WIDTH is sent from the comparator 30 to the OR gate 29. The OR gate 29 calculates a logical sum of the pulse signal WIDTH and the pulse signal received from the comparator 23 indicative of the scanning position of the light beam being at the start position of the effective writing area. The output signal of the OR gate 29 is sent to both the reset input terminal of the counter 27 and the count clock input terminal of the counter 28. The counter 27 resets itself in response to the pulse signal WIDTH that is received from the comparator 30 via the OR gate 29 and resumes the counting operation. Therefore, the counter 27 performs the counting operation repeatedly by the width of each block of the effective writing area until the effective writing area signal LGATE that is received from the comparator 23 is switched to negative and the comparator 30 generates the pulse signal WIDTH that separates the effective writing area into equal intervals.

During the period when the effective writing area signal LGATE received from the comparator 23 is input at the reset input terminal and the effective writing area signal LGATE received from the comparator 23 is negative, i.e., during the period outside the effective writing area, the counter 28 outputs 0. When the effective writing area signal LGATE received from the comparator 23 is set active, the pulse signal indicative of the scanning position of the light beam being at the start position of the effective writing area is received at the count clock input terminal of the counter 28 from the comparator 23 via the OR gate 29, and the counter 28 increments itself and then outputs 1.

Then, the comparator 30 outputs the pulse signal WIDTH that divides effective-writing-area separating every time when dividing at an equal interval during the light beam is scanning the effective writing area. The pulse signal WIDTH is sent from the comparator 30 to the count clock input terminal of the counter 28 via the OR gate 29. The counter 28 increments itself in response to the pulse signal WIDTH when the light beam is scanning the effective writing area.

When the light beam scans out of the effective writing area, the effective writing area signal LGATE received from the comparator 23 is set negative and the count value of the counter 28 is set back to 0. Thus, the count value of the counter 28 indicates the scanning position of the light beam on the effective writing area that is separated into equal blocks and the counter 28 performs the counting operation repeatedly with each surface of the polygon mirror 102a.

The count value of the counter 28 is sent to the RAM 31 as an address signal and thus an address in the RAM 31 is specified by the count value of the counter 28. The RAM 31 is used as a data table that stores therein the numerical values that are set by the CPU 24 as variables and data is read from or write to the RAM 31 under the control of the CPU 24. The CPU 24 writes light-intensity correction data assigned to the scanning position of each block of the effective writing area to the RAM at the corresponding address (address specified by the count value of the counter 28) as prestored data. The light-intensity correction data is used for correcting the beam intensity of the light spot substantially constant at each scanning position.

When the light beams scans the effective writing area, the light-intensity correction data corresponding to the scanning position of the light beam is read from the section of the RAM 31 assigned to the address specified by the count value of the counter 28. The light-intensity correction data is then converted by the DAC 32 to an analog voltage representing the light-intensity correction data and the analog voltage is input to the LD driver 312 via a low pass filter (LPF) 33 as a light-intensity correction signal LDLVL.

The LPF 33 cuts off any high frequency component of the analog signal that has been received from the DAC 32 and outputs a smoothed signal. The smoothed signal prevents the intensity of the light beam from varying between each divided block of the effective writing area, thus smoothing any step-like variations in the density of the image. The LD driver 312 drives the light source of the VCSEL 200 in accordance with the modulation data received from the OR gate 26.

The LD modulated driving by the LD driver 312 involves a pulse width modulation for controlling the pulse width of one dot in accordance with the modulation data, and a power modulation for controlling the intensity of light of one dot in accordance with the modulation data. The VCSEL 200 includes a monitor photodiode (not shown) that is used for monitoring the intensity of light emitted from the light source (laser diode element), and the LD driver 312 controls the intensity of light emitted from the light source by adjusting the illumination current of the light source of the VCSEL 200 in accordance with the output signal of the monitor photodiode. Moreover, the LD driver 312 adjusts the reference intensity of light emitted from the light source in accordance with the scanning position of the light beam using the light-intensity correction signal LDLVL received from the LPF 33.

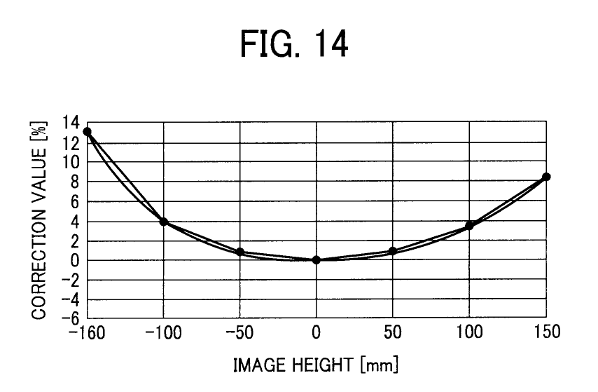

The image forming apparatus according to the present embodiment writes the light-intensity correction data to the RAM 31 in such a manner that the written light-intensity correction data shows, as shown in FIG. 14, the characteristics is reverse to the shading characteristics shown in FIG. 11 and corrects the intensity of light emitted from the light source of the VCSEL 200 by referring to the light-intensity correction data, so that the beam intensity of the light spot becomes constant over the scanned surface.

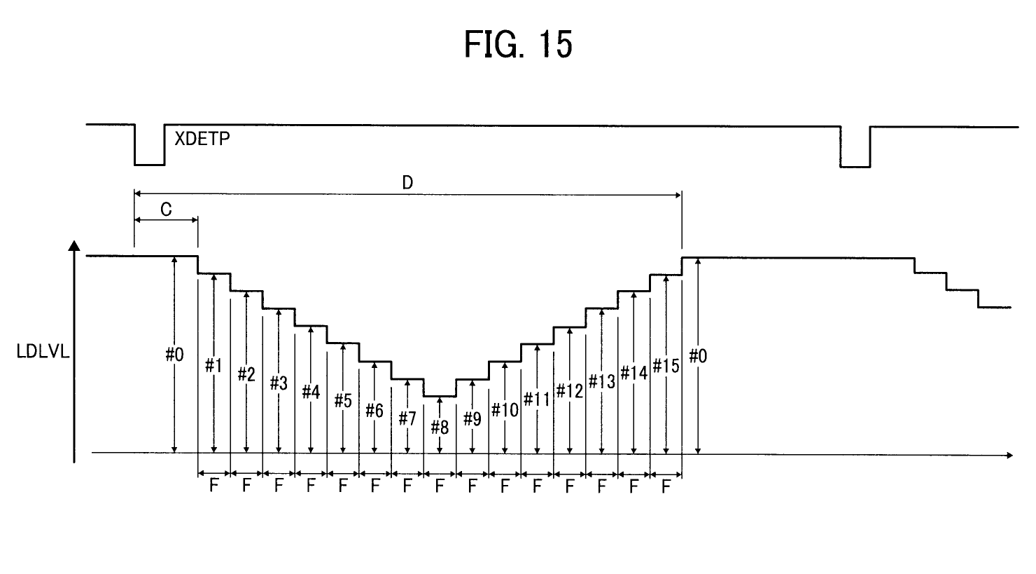

FIG. 15 is a timing chart of the synchronization signal (XDETP) and the light-intensity correction signal LDLVL, when the effective writing area is divided into 15 equal blocks. The light-intensity correction signal LDLVL indicates pieces of light-intensity correction data #1 to #15 assigned to the 15 equal blocks of the effective writing area, where the light-intensity correction data #1 to #15 shows the characteristics that is reverse to the shading characteristics. The light-intensity correction signal LDLVL indicates a constant piece of light-intensity correction data of #0 outside the effective writing area.

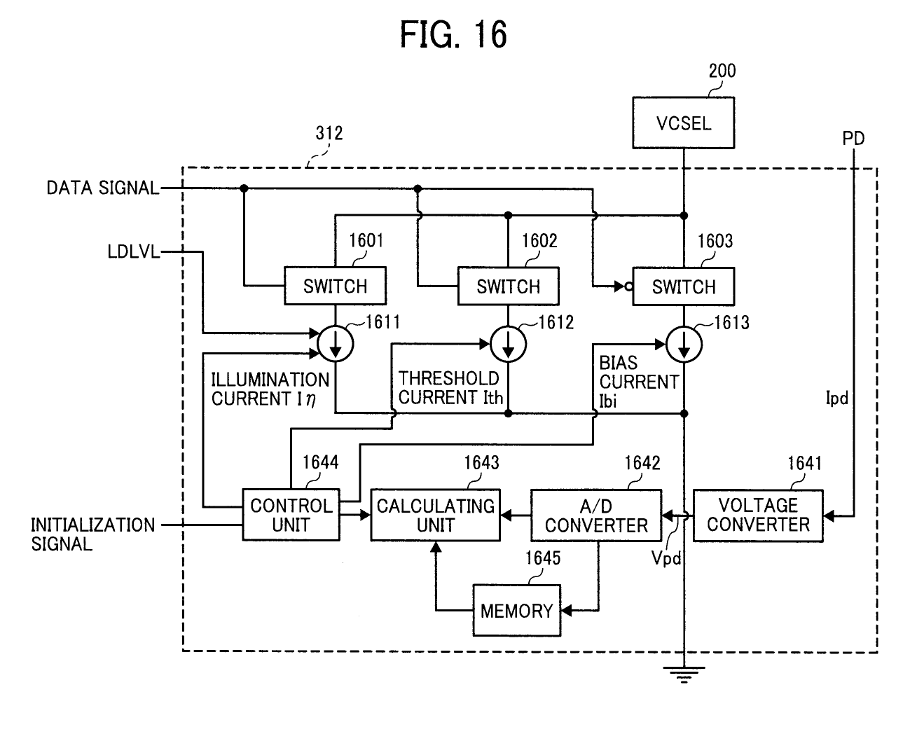

FIG. 16 is a functional block diagram of the LD driver 312. The LD driver 312 includes as shown in FIG. 16 switches 1601 to 1603, an illumination-current generating circuit 1611, a threshold-current generating circuit 1612, a bias-current generating circuit 1613, a control unit 1644, a calculating unit 1643, an A/D converter 1642, a voltage converter 1641, and a memory 1645 as main units. The switches 1601 to 1603, the illumination-current generating circuit 1611, the threshold-current generating circuit 1612, the bias-current generating circuit 1613, the control unit 1644, the calculating unit 1643, the A/D converter 1642, the voltage converter 1641, and the memory 1645 are incorporated in the LD driver 312 as an integrated circuit (IC) and the LD driver 312 is implemented as hardware.

The current applied to the light source of the VCSEL 200 is made up of an illumination current Iη generated by the illumination-current generating circuit 1611, an threshold current Ith generated by the threshold-current generating circuit 1612, and a bias current Ibi generated by the bias-current generating circuit 1613. The illumination-current generating circuit 1611 is, more particularly, an 8-bit DAC (Digital Analog Converter) and can output various current values, for example, from 0 mA to 5 mA by changing the 8-bit data under the control of the control unit 1644. The threshold-current generating circuit 1612 is also an 8-bit DAC and can output various current values, for example, from 0 mA to 5 mA by changing the 8-bit data under the control of the control unit 1644. The bias-current generating circuit 1613 is a 2-bit DAC and can output the current value, for example, either 0 mA or 5 mA by switching the 2-bit data under the control of the control unit 1644.

The switch 1601 switches the illumination current between on and off, the switch 1602 switches the threshold current, and the switch 1603 switches the bias current. The on/off operation is controlled by means of a DATA signal that is a signal for lightening the light source. The bias current is applied when the light source is off. When the DATA signal is low, the switch 1603 is switched on and, in turn, the bias-current generating circuit 1613 generates the bias current. Both the illumination current and the threshold current are applied when the light source is on. When the DATA signal is high, the switches 1601 and 1602 are switched on and, in turn, the illumination-current generating circuit 1611 generates the illumination current and the threshold-current generating circuit 1612 generates the threshold current.

When a monitor photodiode PD (not shown), which is used for monitoring light emitted from the light source of the VCSEL 200, receives the light emitted from the light source, the monitor photodiode PD generates a current Ipd that is directly proportional to the intensity of light received. The current Ipd is converted by the voltage converter 1641 to a voltage Vpd. The voltage Vpd is converted by the A/D converter 1642 into digital data, and the digital data is input to the calculating unit 1643. The calculating unit 1643 calculates the illumination current Iη and the threshold current Ith using the received digital data indicative of the voltage Vpd, and sends results of the calculation to the control unit 1644 as digital data. The control unit 1644 sets, in accordance with the digital data received from the calculating unit 1643, the 8-bit DAC of the illumination-current generating circuit 1611 and the 8-bit DAC of the threshold-current generating circuit 1612, thereby adjusting the illumination current Iη and the threshold current Ith. Moreover, the control unit 1644 individually sets the 2-bit DAC of the bias-current generating circuit 1613, thereby adjusting the bias current Ibi.

Before shipment from a production factory, the image forming apparatus is adjusted in such a manner that the intensity of light beam at the image height 0 (the center) of the scanned surface of the photosensitive element 104a to be the prescribed light intensity as shown in FIG. 10, and the voltage Vpd that is measured when the light source emits the prescribed light intensity beam is stored in the memory 1645 as a voltage Vpd0. The memory 1645 is a nonvolatile memory such as a flash ROM.

Upon receiving an initialization signal from the CPU 24 at the power-on or at the start of latent image formation, the LD driver 312 starts an initializing process. The initializing process involves calculating and setting the threshold current and the illumination current.

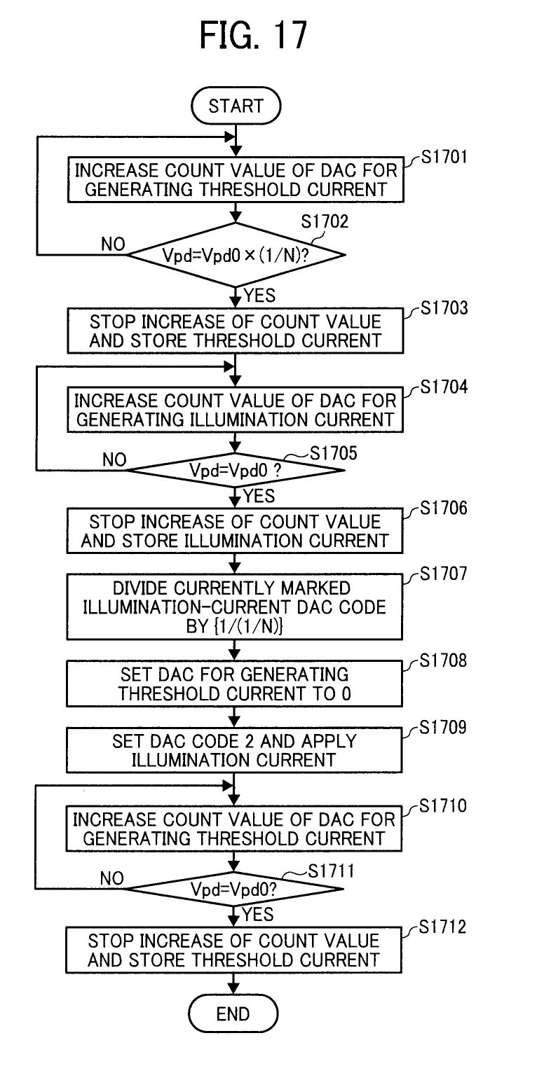

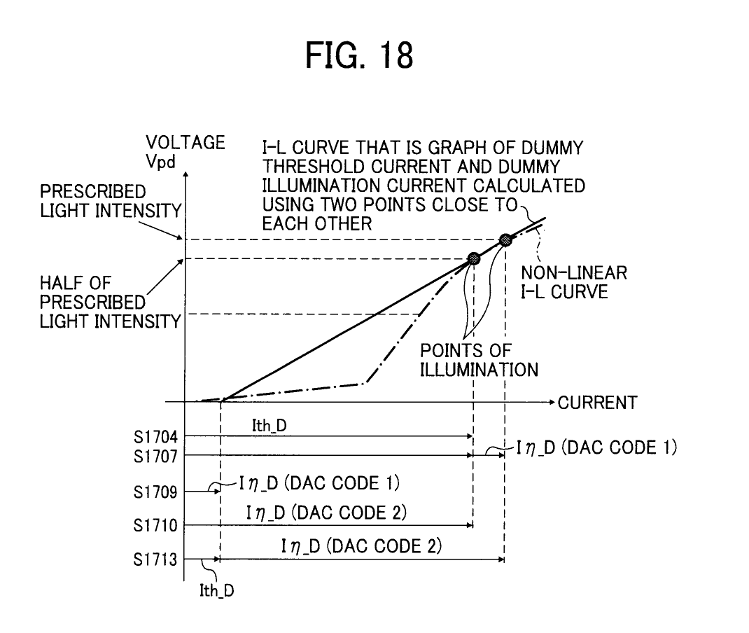

Described below is the initializing process performed by the image forming apparatus involving calculating and setting the threshold current and the illumination current according to the present embodiment. FIG. 17 is a flowchart of the process for calculating and setting the threshold current and the illumination current according to the first embodiment. FIG. 18 is a graph that explains the relation between the current applied to the light source of the VCSEL 200 and the voltage Vpd, where the voltage Vpd indicates the intensity of light emitted. The step numbers shown in FIG. 18 are referred to those steps shown in FIG. 7. In the present embodiment, it is assumed that the bias current is set to 0 mA by the bias-current generating circuit 1613.

Upon receiving an initialization signal (e.g., high to low) from the CPU 24 at the power-on or at the start of latent image formation, the LD driver 312 starts the initializing process. The initialization signal is input to the control unit 1644 included in the LD driver 312. Upon receiving the initialization signal, the control unit 1644 gradually increases the count value indicated by the 8-bit data of the DAC of the threshold-current generating circuit 1612 (hereinafter, “Ith_D”) from 0 (Step S1701). As the count value increases, the increased count value is applied to the light source of the VCSEL 200 and the light source of the VCSEL 200 emits light in accordance with the increased current value.

As the count value indicated by the 8-bit data of the DAC of the threshold-current generating circuit 1612 increases and the light source emits light in accordance with the increased count value, the increased current Ipd that is directly proportional to the intensity of light emitted is input via the PD. The current Ipd is converted to the voltage Vpd by the voltage converter 1641 and the control unit 1644 receives the voltage Vpd via the calculating unit 1643.

The calculating unit 1643 multiplies the voltage Vpd0 by 1/N (N is a real number larger than 1 and less than 2), where, the voltage Vpd0 is stored in the memory 1645 before shipment as the voltage measured when the light source emits the prescribed light intensity. The control unit 1644 compares the value of the voltage Vpd with the voltage Vpd0 multiplied by 1/N (Step S1702). It is noted that the value (Vpd0×(1/N)) or the voltage Vpd0 multiplied by 1/N (N is a real number larger than 1 and less than 2) corresponds to an intensity close to the prescribed light intensity. If 85% of the prescribed light intensity is selected as an intensity close to the prescribed light intensity as in the example shown in FIG. 9, then 1/N=0.85.

Until the voltage Vpd increases to the voltage Vpd0×(1/N) (No at Step S1702), the control unit 1644 increases the count value indicated by Ith_D of the DAC of the threshold-current generating circuit 1612.

When the value of the voltage Vpd increases equal to the voltage Vpd0×(1/N) (Yes at Step S1702), the control unit 1644 stops increase of the count value indicated by Ith_D of the DAC of the threshold-current generating circuit 1612 and stores the value of the threshold current (Step S1703).

After that, with the other conditions unchanged, the control unit 1644 gradually increases the count value indicated by the 8-bit data of the DAC of the illumination-current generating circuit 1611 (hereinafter, “Iη_D”) from 0 (Step S1704). As the count value indicated by the 8-bit data of the DAC of the illumination-current generating circuit 1611 increases and the light source emits light in accordance with the increased current, the increased current Ipd indicative of the intensity of light received is converted into the voltage Vpd by the voltage converter 1641 and the control unit 1644 compares the increased voltage Vpd with the value of the voltage Vpd0 stored in the memory 1645 (Step S1705). Until the voltage Vpd increases to the voltage Vpd0 (No at Step S1705), the control unit 1644 increases the count value indicated by Iη_D of the DAC of the illumination-current generating circuit 1611.

When the voltage Vpd increases equal to the voltage Vpd0 (Yes at Step S1705), the control unit 1644 stops increase the count value of the DAC of the illumination-current generating circuit 1611 and stores the 8-bit value of the DAC of the illumination current (hereinafter, “DAC code 1”) (Step S1706). Thus, the relation is calculated between the voltage value, which is based on the value of the illumination current, and the intensity of light emitted from the light source of the VCSEL 200. More particularly, the proportional relation between the illumination current and the intensity of light emitted is calculated using the difference between the voltage values, one voltage value being corresponding to the illumination current of the prescribed light intensity and the other voltage value being corresponding to the illumination current of the intensity close to the prescribed light intensity.

The control unit 1644 then sends the DAC code 1 of the illumination current to the calculating unit 1643. The calculating unit 1643 calculates, using the received DAC code 1 of the illumination current, the DAC code of the illumination current to be set (hereinafter, “DAC code 2”) with the above proportional relation. More particularly, as it is clear from the above proportional relation that the DAC code 1 of the illumination current received from the control unit 1644 is equal to the DAC code 2 of the illumination current multiplied by {1−(1/N)}; therefore, the calculating unit 1643 calculates the DAC code 2 of the illumination current by dividing the DAC code 1 by {1−(1/N)} (Step S1707).

After that, the control unit 1644 sets data of the DAC of the threshold-current generating circuit 1612 back to 0, thereby setting the threshold current to 0 (Step S1708). The control unit 1644 then receives the DAC code 2 of the illumination current that is calculated by the calculating unit 1643 and sets the illumination-current generating circuit 1611 to the DAC code 2 of the illumination current, and the illumination-current generating circuit 1611 applies the illumination current with the DAC code 2 to the light source of the VCSEL 200 (Step S1709).

The control unit 1644 then re-increases the count value indicated by the 8-bit data of the DAC of the threshold-current generating circuit 1612 from 0 (Step S1710). As the count value indicated by the 8-bit data of the DAC increases, the control unit 1644 receives the increased voltage Vpd via the calculating unit 1643 and compares the value of the received voltage Vpd with the voltage Vpd0 that is stored in the memory 1645, where the voltage is measured when the prescribed light intensity is emitted (Step S1711). Until the value of the voltage Vpd increases to the voltage Vpd0 (No at Step S1711), the control unit 1644 increases the count value indicated by the 8-bit data of the DAC of the threshold-current generating circuit 1612.

When the value of the voltage Vpd increases equal to the voltage Vpd0, where the voltage is measured when the prescribed light intensity is emitted (Yes at Step S1711), the control unit 1644 stops increase of the count value indicated by the DAC of the threshold-current generating circuit 112 and stores the threshold current as the threshold current to be set (Step S1712). The initializing process then goes to end.

After the initializing process, the threshold current is set to the pseudo threshold current different from the true threshold current, and the illumination current is set to the pseudo illumination current different from the true illumination current. However, as described above, the intensity of light is adjusted during the shading correction to a value within, in general, a relatively small range from −15% to +15% with respect to the prescribed light intensity; therefore, the curve of the I-L curve is substantially equal to the I-L curve that is calculated using the pseudo threshold current and the pseudo illumination current. Therefore, the substantially intended corrected intensity of light is obtained after the shading correction is performed using the I-L curve that is calculated using the pseudo threshold current and the pseudo illumination current.

It is noted that the above processes from Steps S1701 to S1712 are performed with each light source included in the VCSEL 200 (each of the two or more laser diode elements) and the shading correction is performed for each light source.

As described above, in the present embodiment, the proportional relation between the amount of current and the intensity of light emitted is calculated using the two points of intensities of light emitted, one being the prescribed light intensity and the other being the intensity close to the prescribed light intensity. The illumination current is calculated using the proportional relation. The shading correction is then performed using the calculated illumination current. Therefore, even if the I-L curve is non-linear, an accurate shading correction is performed.

Moreover, in the present embodiment, the VCSEL 200 that includes a plurality of light sources (laser diode elements) is used to scan the scanned surface of the photosensitive element 104a with a plurality of light beams; therefore, the differences between the intensities of the light beams are reduced, which prevents forming of undesirable images with for example banding and, resulting preferable image printing.

Furthermore, in the present embodiment, the intensity of light is adjusted during the shading correction to a value within, in general, a relatively small range from −15% to +15% with respect to the prescribed light intensity and the curve of the I-L curve is substantially linear within the small area; therefore, by calculating the proportional relation between the amount of current and the intensity of light emitted using the prescribed light intensity and the intensity close to the prescribed light intensity, a highly accurate adjustment of the intensity of light is achieved and this enables scanning of the scanned surface of the photosensitive element 104a with a light beam that has a constant intensity.

### Second Embodiment

The process for calculating the proportional relation between the current applied to the light source of the VCSEL 200 and the intensity of the light beam according to the first embodiment involves gradually increasing the count value of the threshold current and the count value of the illumination current, determining whether the voltage corresponding to the increased intensity of light emitted is equal to the voltage value corresponding to the prescribed light intensity, determining whether the voltage corresponding to the increased intensity of light emitted is equal to the voltage value corresponding to 85% of the prescribed light intensity, and calculating the difference between the voltage value corresponding to the prescribed light intensity and the voltage value corresponding to 85% of the prescribed light intensity. In the present embodiment, the amount of current that causes the light source to emit the prescribed light intensity is called “prescribed current value” and the prescribed current value is prestored. Each of the prescribed current value and 85% of the prescribed current value is applied to the light source for illumination and the voltage value is measured at each illumination. The proportional relation between the current applied to the light source of the VCSEL 200 and the intensity of the light beam is calculated using the difference between the measured voltage values.

The mechanical structure of the image forming apparatus according to the present embodiment is the same as the structure shown in FIG. 1. As the light source unit, the VCSEL 200 is also used in the present embodiment in the same manner as in the first embodiment shown in FIG. 2. The image forming apparatus according to the present embodiment has the control unit 300, the GAVD 310, the synchronization detecting device 210, the output-data control unit 344 of the GAVD 310, and the LD driver 312 those having the same configuration as described in the first embodiment with reference to FIGS. 4, 5, 12, 13, and 16, respectively. Moreover, the shading correction is performed in the present embodiment in the same manner as in the shading correction described in the first embodiment.

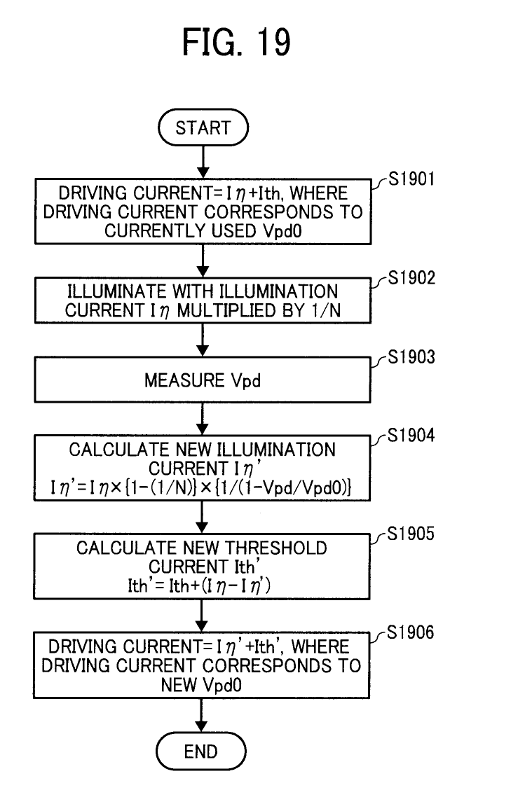

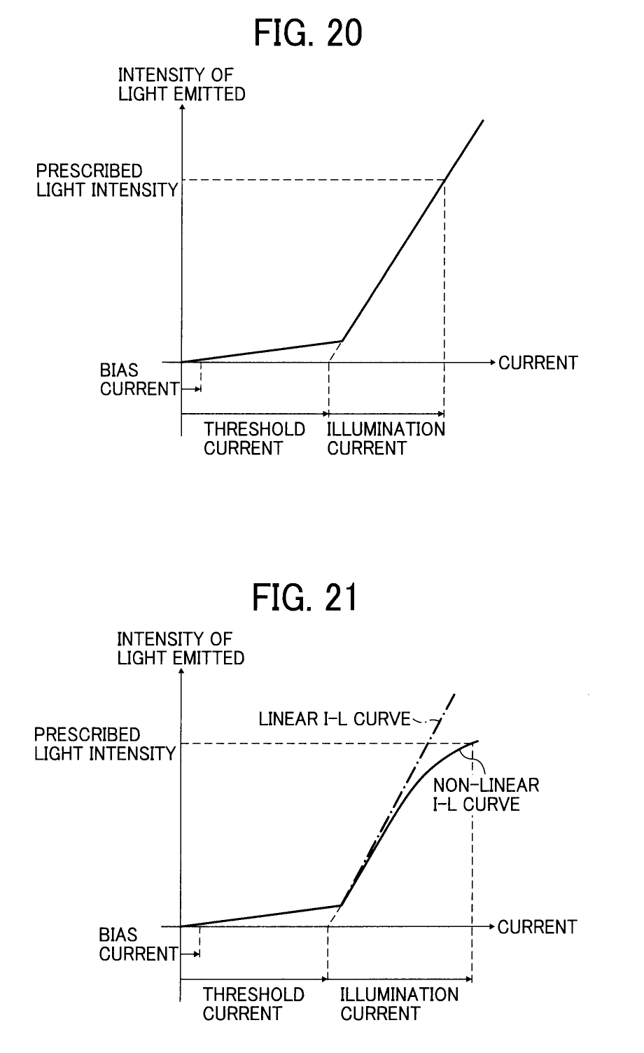

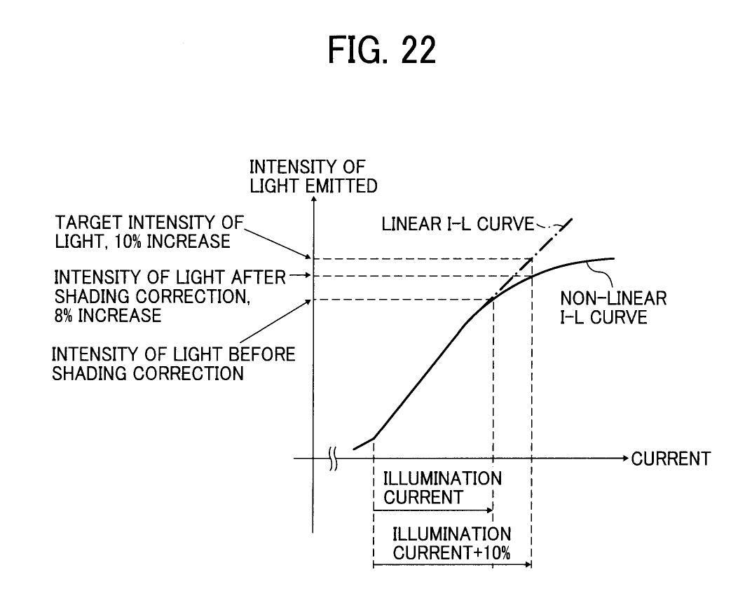

The present embodiment is different from the first embodiment in that the process performed by the calculating unit 1643 and the control unit 1644 of the LD driver 312 for calculating and setting the threshold current and the illumination current. FIG. 19 is a flowchart of the process for calculating and setting the threshold current and the illumination current according to the second embodiment. In the present embodiment, it is assumed that the bias current is set to 0 mA by the bias-current generating circuit 1613.

Upon receiving an initialization signal (e.g., high to low) from the CPU 24 at the power-on or at the start of latent image formation, the LD driver 312 starts the initializing process. The initialization signal is input to the control unit 1644 included in the LD driver 312. Upon receiving the initialization signal, the control unit 1644 adjusts the DAC of the illumination-current generating circuit 1611 and the DAC of the threshold-current generating circuit 1612 so that the driving current corresponding to the currently used prescribed light intensity (the voltage value Vpd0) is set equal to the sum of the illumination current Iη and the threshold current Ith, where the illumination current Iη is the prescribed current value corresponding to the prescribed light intensity (the voltage value Vpd0) and the threshold current Ith is the prescribed current value corresponding to the prescribed light intensity (the voltage value Vpd0) (Step S1901).

The calculating unit 1643 multiplies the illumination current Iη by 1/N (N is a real number larger than 1 and less than 2), where the illumination current Iη is the prescribed current value corresponding to the prescribed light intensity (the voltage value Vpd0). The control unit 1644 adjusts the value of the DAC of the illumination-current generating circuit 1611 so that the illumination current value of the illumination current Iη is set to the product and applies the adjusted illumination current value to the light source, thereby causing the light source to emit light (Step S1902).

The control unit 1644 measures the voltage value Vpd via the A/D converter 1642 and the calculating unit 1643, where the voltage value Vpd is an output of the voltage converter 1641 produced by converting the current value that has been received from the PD when the light source emits light (Step S1903).

It is noted that the illumination current Iη is the prescribed current value corresponding to the prescribed light intensity, and the illumination current Iη multiplied by 1/N (N is a real number larger than 1 and less than 2) corresponds to the illumination current corresponding to the intensity close to the prescribed light intensity. If 85% of the prescribed light intensity is selected as an intensity close to the prescribed light intensity as in the example shown in FIG. 9, then 1/N=0.85.

Thus, the proportional relation is calculated between the voltage values Vpd0 and Vpd and the illumination currents Iη (prescribed current value) and Iη×(1/N). The calculating unit 1643 calculates a new illumination current Iη′ with Equation (1) using the proportional relation (Step S1904).

Iη′=Iη×{1−(1/N)}×{1/(1−Vpd/Vpd0)} (1)

The calculating unit 1643 then calculates a new threshold current Ith′ with Equation (2) using the above proportional relation (Step S1905).

Ith′=Ith+(Iη−Iη′) (2)

The control unit 1644 adjusts the value of the DAC of the illumination-current generating circuit 1611 and the value of the DAC of the threshold-current generating circuit 1612 so that the driving current corresponding to a new prescribed light intensity (the voltage value Vpd0) is set equal to the sum of the new illumination current Iη′ calculated using Equation (1) and the new threshold current Ith′ calculated using Equation (2) (Iη′+Ith′) and applies the adjusted driving current to the light source (Step S1906).

It is noted that the above processes from Steps S1901 to S1906 are performed with each light source included in the VCSEL 200 (each of the two or more laser diode elements) and the shading correction is performed for each light source.

As described above, in the present embodiment, each of the prescribed current value that corresponds to the prescribed light intensity and an approximate illumination current value close to the prescribed current vale, for example, 85% of the prescribed current vale is applied to the light source for illumination so as to obtain a different voltage value measured at each illumination; the proportional relation between the current applied to the light source of the VCSEL 200 and the intensity of the light beam is calculated by using the different voltage value; the shading correction is then performed by calculating the driving current using the calculated proportional relation and causing the light source to emit light by the driving current; therefore, even if the I-L curve is non-linear, an accurate shading correction is performed.

Moreover, in the same manner as in the first embodiment, the VCSEL 200 that includes a plurality of light sources (laser diode elements) is used in the second embodiment to scan the scanned surface of the photosensitive element 104a with a plurality of light beams; therefore, the differences between the intensities of the light beams are reduced, which prevents formation of undesirable images with, for example, banding and, as a result enabling preferable image printing.

Although, in the first embodiment and the second embodiment, 85% of the prescribed light intensity is used as the intensity close to the prescribed light intensity, some other values can be used.

Moreover, although, in the first embodiment and the second embodiment, the relation between the intensity of light emitted and the current is calculated using two points, one being the prescribed light intensity and the other being the intensity close to the prescribed light intensity, the relation can be calculated in some other manners. For example, the relation between the intensity of light emitted and the current can be calculated using two points of intensities of light, both close to the prescribed light intensity.

Furthermore, although, in the first embodiment and the second embodiment, the relation between the intensity of light emitted and the current is calculated using two points, one being the prescribed light intensity and the other being the intensity close to the prescribed light intensity, the relation can be calculated in some other manners. For example, the relation between the intensity of light emitted and the current can be calculated using three or more points of intensities of light that are equal to or close to the prescribed light intensity.

Moreover, although, in the first embodiment and the second embodiment, the VCSEL 200 is used as a light source that emits light beams, any light sources can be used so long as it can emit a plurality of light beams.

Furthermore, although, in the image forming apparatus according to any of the first embodiment and the second embodiment, the LD driver 312 is implemented as hardware, the LD driver 312 can be implemented as software. If the LD driver 312 is implemented as software, a light-intensity correction program executed by the image forming apparatus according to any of the first embodiment and the second embodiment is prestored in a ROM or the like. Alternatively, the light-intensity correction program executed by the image forming apparatus according to any of the first embodiment and the second embodiment can be stored in a form of a file installable or executable by the image forming apparatus, in a recording medium such as a CD-ROM, a flexible disk (FD), a CD-R, and a digital versatile disk (DVD).

Alternatively, the light-intensity correction program executed by the image forming apparatus according to any of the first embodiment and the second embodiment can be stored in another computer connected to the image forming apparatus via a network such as the Internet, and can be downloaded to the image forming apparatus via the network. The light-intensity correction program executed by the image forming apparatus according to any of the first embodiment and the second embodiment can be delivered or distributed via a network such as the Internet.

If the LD driver 312 according to any of the first embodiment and the second embodiment is implemented as software, because the light-intensity correction program executed by the image forming apparatus is made up of modules that implement the above units (the control unit, the calculating unit, and so on), when the CPU (processor), which is a hardware component, reads the light-intensity correction program from the above ROM and executes the read light-intensity correction program, the above modules are loaded and created on a main memory thereby implementing the control unit, the calculating unit, and so on.

According to the present invention, as an effect of shading correction, even when the characteristics of a light source are expressed by a non-linear line on a graph of current against intensity of light, the light source is adjusted to emit a laser beam with a constant intensity along a scanning line.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a light source that emits light beam;
an illumination-current generating unit that generates an illumination current that causes the light source to emit the light beam;
a deflecting optical unit that deflects the light beam and collects the deflected light beam on a scanned surface of a photosensitive element, thereby forming a light spot and scanning the scanned surface with the light spot;
a detecting unit that detects a scanning position of the light spot on the scanned surface;
a control unit that calculates a relation between a value of the illumination current and an intensity of light emitted from the light source based on a plurality of intensities of emitted light,
each intensity of the plurality of intensities being close to or equal to a prescribed light intensity, and
causes the illumination-current generating unit to generate the illumination current based on the relation; and
a correcting unit that corrects the intensity of the light beam by correcting the illumination current based on predetermined correction data defined for each scanning position.

2. The image forming apparatus according to claim 1, further comprising
a threshold-current generating unit that supplies a predetermined threshold current to the light source, wherein
the control unit
causes the threshold-current generating unit to generate the threshold current based on the relation and
causes the illumination-current generating unit to generate the illumination current based on the threshold current that has been generated.

3. The image forming apparatus according to claim 2, further comprising
a photoelectric converting unit that converts each current, which corresponds to each of the plurality of light intensities, into a voltage value, wherein
the control unit
acquires the voltage value converted by the photoelectric converting unite, while increasing both the threshold current and the illumination current individually,
calculates difference of the voltage values that correspond to the plurality of light emitting amounts, and
calculates the relation based on the difference of the voltage values.

4. The image forming apparatus according to claim 3, wherein
the control unit
calculates a pseudo illumination current value based on the difference of the voltage values that correspond to the plurality of light emitting amounts,
causes the illumination-current generating unit to generate the illumination current of the pseudo illumination current value, and
the correcting unit corrects the pseudo illumination current based on the correction data.

5. The image forming apparatus according to claim 2, further comprising
a photoelectric converting unit that converts each current, which corresponds to each of the plurality of light intensities, into a voltage value, wherein
the control unit
causes the threshold-current generating unit to generate the threshold current and causes the illumination-current generating unit to generate the plurality of the illumination currents so that the plurality of the illumination-current are to be within a range close to the speculated current value,
calculates the difference between voltage values corresponding to the plurality of light emitting values based on the voltage values acquired by emitting the light source, and
calculates the relation based on the difference between the voltage values.

6. The image forming apparatus according to claim 1, wherein
the plurality of intensities of emitted light are either the prescribed light intensity or an intensity close to the prescribed light intensity.

7. The image forming apparatus according to claim 1, wherein
the light source includes a plurality of light sources, and
the control unit
calculates the relation, for each of the light sources, between the value of the illumination current and the intensity of light emitted from the light source based on a plurality of intensities of light emitted, the intensities of light emitted being fall within a close range to a predetermined speculated light intensity and
causes the illumination-current generating unit to generate the illumination current based on the relation.

8. The image forming apparatus according to claim 7, wherein
the light sources are surface emitting lasers.

9. A light-intensity correction method performed in an image forming apparatus, the image forming apparatus including
a light source that emits a light beam;
an illumination-current generating unit that generates an illumination current, wherein the illumination current causes the light source to emit the light beam;
a deflecting optical unit that deflects the light beam and collects the deflected light beam on a scanned surface of a photosensitive element, thereby forming a light spot and scanning the scanned surface with the light spot; and
a detecting unit that detects a scanning position of the light spot on the scanned surface; the light-intensity correction method comprising:
calculating a relation between the value of the illumination current and the intensity of light emitted from the light source based on a plurality of intensities of emitted light, each intensity of the plurality of intensities being close to or equal to a prescribed light intensity;
causing the illumination-current generating unit to generate the illumination current based on the relation; and
correcting the intensity of the light beam by correcting the illumination current based on predetermined correction data defined for each scanning position.

10. The light-intensity correction method according to claim 9, the image forming apparatus further including
a threshold-current generating unit that supplies a predetermined threshold current to the light source, wherein
causing the threshold-current generating unit to generate the threshold current based on the relation by the control unit and
causing the illumination-current generating unit to generate the illumination current based on the threshold current that has been generated by the control unit.

11. The light-intensity correction method according to claim 10, the image forming apparatus further including
a photoelectric converting unit that converts each current, which corresponds to each of the plurality of light intensities, into a voltage value, wherein
acquiring the voltage value converted by the photoelectric converting unite, while increasing both the threshold current and the illumination current individually by the control unit,
calculating difference of the voltage values that correspond to the plurality of light emitting amounts by the control unit, and
calculating the relation based on the difference of the voltage values by the control unit.

12. The light-intensity correction method according to claim 11, wherein
calculating a pseudo illumination current value based on the difference of the voltage values that correspond to the plurality of light emitting amounts by the control unit,
causing the illumination-current generating unit to generate the illumination current of the pseudo illumination current value by the control unit, and
correcting the pseudo illumination current based on the correction data by the correcting unit.

13. The light-intensity correction method according to claim 10, the image forming apparatus further including
a photoelectric converting unit that converts each current, which corresponds to each of the plurality of light intensities, into a voltage value, wherein
causing the threshold-current generating unit to generate the threshold current and causes the illumination-current generating unit to generate the plurality of the illumination currents so that the plurality of the illumination-current are to be within a range close to the speculated current value by the control unit,
calculating the difference between voltage values corresponding to the plurality of light emitting values based on the voltage values acquired by emitting the light source by the control unit, and
calculating the relation based on the difference between the voltage values by the control unit.

14. The light-intensity correction method according to claim 9, wherein
the plurality of intensities of emitted light are either the prescribed light intensity or an intensity close to the prescribed light intensity.

15. The light-intensity correction method according to claim 9, wherein
the light source includes a plurality of light sources, and
calculating the relation, for each of the light sources, between the value of the illumination current and the intensity of light emitted from the light source based on a plurality of intensities of light emitted, the intensities of light emitted being fall within a close range to a predetermined speculated light intensity by the control unit and
causing the illumination-current generating unit to generate the illumination current based on the relation by the control unit.

16. The light-intensity correction method according to claim 15, wherein
the light sources are surface emitting lasers.

17. A computer program product comprising a computer-usable medium having computer-readable program codes embodied in the medium for a light-intensity correction method performed in an image forming apparatus, the image forming apparatus including
a light source that emits a light beam;
an illumination-current generating unit that generates an illumination current, wherein the illumination current causes the light source to emit the light beam;
a deflecting optical unit that deflects the light beam and collects the deflected light beam on a scanned surface of a photosensitive element, thereby forming a light spot and scanning the scanned surface with the light spot; and
a detecting unit that detects a scanning position of the light spot on the scanned surface; the program codes when executed causing a computer to execute:
calculating a relation between the value of the illumination current and the intensity of light emitted from the light source based on a plurality of intensities of emitted light, each intensity of the plurality of intensities being close to or equal to a prescribed light intensity;
causing the illumination-current generating unit to generate the illumination current based on the relation; and
correcting the intensity of the light beam by correcting the illumination current based on predetermined correction data defined for each scanning position.
